(19) United States
(12) Patent Application Publication
(10) Pub. No.: US 2023/0327155 A1
(43) Pub. Date: Oct. 12, 2023

(54) FUEL CELL SYSTEMS AND METHODS

(71) Applicants: Ceres Intellectual Property Company Limited, Horsham, West Sussex (GB); Miura Company Limited, Ehime-ken (JP)

(72) Inventors: Oliver Postlethwaite, Horsham, West Sussex (GB); Simone Dozio, Horsham, West Sussex (GB); Yuto Wakita, Ehime-ken (JP); Yoshiki Nakazato, Ehime-ken (JP); Toshifumi Sone, Ehime-ken (JP); Takuya Saeki, Ehime-ken (JP); Yasukuni Tanaka, Ehime-ken (JP)

(21) Appl. No.: 18/023,299

(22) PCT Filed: Aug. 17, 2021
(86) PCT No.: PCT/EP2021/072860

§ 371 Date: Feb. 24, 2023

(30) Foreign Application Priority Data
Aug. 27, 2020 (GB) 2013439.1

(51) Int. Cl. H01M 8/04746; H01M 8/04029; H01M 8/04119; H01M 8/0662; H01M 8/0432

(52) U.S. Cl. CPC H01M 8/04768; H01M 8/04029; H01M 8/04164; H01M 8/0662; H01M 8/04358; H01M 2008/1293

(57) ABSTRACT

A fuel cell system (200) and a method (900) for controlling temperature of a heat transfer fluid in a fuel cell system (200). The system (200) comprising at least one fuel cell stack (205) comprising at least one fuel cell, and having an anode inlet, an anode off-gas outlet for flow of anode off-gas. The system (200) further comprising a first heat exchanger (215) coupled to receive the anode off-gas which has been output form the anode off-gas outlet, the first heat exchanger (215) configured to exchange heat between the anode off-gas and a heat transfer fluid to cool the anode off-gas and heat the heat transfer fluid. The system (200) further comprising a second heat exchanger (230) that is configured to provide heat to the heat transfer fluid and a heat removal region (235) that is configured to remove heat from the heat transfer fluid. The system (200) further comprising a pump (240) configured to pump the heat transfer fluid around a fluid circuit (225) in a flow direction of: heat removal region (235) where thermal energy is removed, second heat exchanger (230) where thermal energy is added, first heat exchanger (215) where thermal energy is added. The method (900) comprises controlling (920, 945) the pump speed and controlling (925, 940) a mass flow rate of a medium to control the rate of heat removal in the heat removal region (235).

### FIELD OF THE INVENTION

The present invention is concerned with fuel cell systems and methods.

### BACKGROUND TO THE INVENTION

Teachings of fuel cells, fuel cell stacks, fuel cell stack assemblies, and heat exchanger systems, arrangements and methods are known to one of ordinary skill in the art, and in particular include WO2008053213A, which is incorporated herein by reference in its entirety. In particular, the present invention seeks to improve the systems and methods disclosed in WO2008053213A.

A typical fuel cell converts chemical energy in the form of a fuel and an oxidant to electrical energy. The fuel used by the fuel cell may be hydrogen gas, and the oxidant oxygen, and exhaust gasses are limited to water. It is preferable to operate a fuel cell system on natural gas, in which case the natural gas may be reformed to hydrogen in the fuel cell system. To do so requires a supply of water to reform the natural gas to hydrogen.

Operating hydrocarbon fuelled fuel cell (for example a SOFC (solid oxide fuel cell)) systems where the fuel cell stack operates in the 450-650 Deg C. range (intermediate-temperature solid oxide fuel cell; IT-SOFC), more particularly in the 520-620 Deg C. temperature range, results in a challenging set of technical problems being encountered.

The delivery of fuel cell stack cooling (in particular by pumps/blowers) is a substantial system parasitic load (typically, the largest system parasitic load). Since the fuel cell stack provides the electrical power to the pumps/blowers to provide fuel cell stack cooling, an increased cooling demand leads to an increased power demand, requiring increased power generation, reducing the overall efficiency of the system.

FIG. 1 is drawn from WO2008053213A in which these and other problems are addressed. FIG. 1 is a diagram showing a heat exchange system for use in a fuel cell system. Three heat exchangers are shown. These are a first heat exchange element 26 which may be referred to as the anode off-gas condenser heat exchanger, a second heat exchange element 24 which may be referred to as the fuel cell heat recovery/burner off gas condenser heat exchanger and a further heat exchange element 22 which may be, for example, an air heater heat exchanger. Further, four fluid paths are shown. These are 1. a first fluid path 10 of heat transfer fluid through the first heat exchange element 26 and subsequently through the second heat exchange element 24; 2. a second fluid path 12 through the further heat exchange element 22 and subsequently through the first heat exchange element 26; 3. a third fluid path 14 through the second heat exchange element 24; and 4. a fourth fluid path 16 through the further heat exchange element 22.

The first fluid flow path 10 comes to the first heat exchange element 26 from a cold side of a thermal store or heat rejection device or unit, and exits the second heat exchange element 24 to a warm side of a thermal store or radiator heat rejection device or unit. The first fluid is water,

The second fluid flow path 12 comes to the further heat exchange element 22 from an anode side active area of a fuel cell system, and subsequently exits the first heat exchange element 26 to a burner of a fuel cell system. The second fluid is anode off-gas from the fuel cell.

The third fluid flow path 14 contains burner off-gas and comes from a pre-heater burner to the second heat exchange element 24, and exits as exhaust. The fourth fluid flow path 16 is air, which is passed through the further heat exchange element 24 and is then output to be used in the air side flow of the fuel cell.

In operation, hot anode off-gas flows from the fuel cell along the second fluid path 12 through the further heat exchange element 22. Heat is exchanged from the anode off-gas to the air drawn in to the system along the fourth fluid path 16. Heat is passed from the anode off-gas to the air in the further heat exchange element 22, cooling the anode off gas and warming the air before it enters the fuel cell assembly. The further heat exchange element 22 is a gas-gas heat exchanger. The anode off-gas then continues along the second fluid path 12 to the first heat exchange element 26, which receives heat transfer fluid in the form of water along the first fluid flow path 10. The anode off gas is further cooled by the first heat exchange element 26, which is a condenser heat exchanger, and so removes latent heat of fusion energy from the anode off-gas. The heat transfer fluid is warmed in this heat exchange.

The heat transfer fluid then passes along the first fluid path 10 to the second heat exchange element 24 and receives heat energy from the burner off gas in the third fluid flow path 14. The second heat exchange element 24 is also a condenser heat exchanger, and so removes latent heat of fusion energy from the burner off-gas. The heat transfer fluid is further warmed in this heat exchange process.

A fuel cell stack tail-gas burner is positioned subsequent to the anode off-gas condenser heat exchanger. The tail-gas burner burns any remaining fuel in the anode off-gas with oxidant, typically by combusting with the hot cathode off-gas. The burner off gas (combustion products from the burner), Fluid 3, are routed to the second heat exchange element 24.

Condensate from the fuel cell heat recovery/burner off-gas condenser heat exchanger and the anode off-gas condenser heat exchanger is collected and fed to a condensate collection tank where it can be filtered, degassed, conditioned and stored in the condensation water storage tank ready for use as water for a steam generator of a burner/reformer unit of the fuel cell system.

By reclaiming water from off-gas(es) exiting the fuel cell, the water can be reused in a reforming process to provide fuel to the fuel cell. This reduces, and can eliminate, the need for a separate supply of water to the fuel cell system as a whole. Because of this, significantly less processing is required for water used in the system, which results in smaller processing (e.g. softening) unit requirements, and overall size of the system.

In the arrangement of WO2008053213A, the heat transfer fluid will cool the anode off-gas before cooling the burner off-gas in order to recover a large amount of latent heat, and hence condensate, from the anode off-gas because the heat transfer fluid is at its coolest upon entry to the anode off-gas condenser.

However, recovery of water, in the form of condensate, from the anode off-gas means that the cooled anode off-gas has a low humidity and can lead to carbon formation (coking) in the anode off-gas downstream of the anode off-gas condenser, including the burner. Coking can lead to system failure by build up of carbon deposits in the anode off-gas stream, and in particular in the burner.

The present invention seeks to address, overcome or mitigate at least one of the prior art disadvantages.

### SUMMARY OF THE INVENTION

According to a first aspect of the present invention, there is provided a fuel cell system comprising: at least one fuel cell stack comprising at least one fuel cell, and having an anode inlet, an anode off-gas outlet for flow of anode off-gas; a first heat exchanger coupled to receive the anode off-gas which has been output form the anode off-gas outlet, the first heat exchanger configured to exchange heat between the anode off-gas and a heat transfer fluid to cool the anode off-gas and heat the heat transfer fluid; a second heat exchanger that is configured to provide heat to the heat transfer fluid; a heat removal region that is configured to remove heat from the heat transfer fluid; and a pump configured to pump the heat transfer fluid around a fluid circuit in a flow direction of: heat removal region where thermal energy is removed, second heat exchanger where thermal energy is added, first heat exchanger where thermal energy is added.

The system is configured to provide a balance between coking and water recovery from the anode off-gas while minimising parasitic electrical consumption. The temperature of the heat transfer fluid upon entry to the first heat exchanger determines the amount of water recovered from the anode off-gas, and therefore the humidity of the anode off-gas subsequent to (also referred to as downstream of) the first heat exchanger. Water is recovered from the anode off-gas to provide a supply of water to a reformer (used to reform fuel, e.g. natural gas, to hydrogen for use in the fuel cell).

It is desirable for at least two reasons to recover sufficient water from the anode off-gas that the fuel cell system is self-sufficient in water: i) no external supply of water is required and ii) the water recovered is pure water and requires no purification, unlike an external supply of water.

It is desirable to avoid coking conditions in the anode off-gas stream, as coking may lead to system failure due to build-up of carbon deposits on components (for example in a burner) in the anode off-gas stream.

A low temperature of the heat transfer fluid upon entry to the first heat exchanger provides good water recovery from the anode off-gas, and therefore allows the fuel cell system to be self-sufficient in water, but risks coking in the anode off-gas in components subsequent to the first heat exchanger due to low humidity of the anode off-gas. A high temperature of the heat transfer fluid upon entry to the first heat exchanger reduces the risk of coking in the anode off-gas in components subsequent to the first heat exchanger due to high humidity of the anode off-gas, but provides lesser water recovery from the anode off-gas and may not allow the fuel cell system to be self-sufficient in water.

The second heat exchanger may be positioned in the fluid circuit between the heat removal region and the first heat exchanger. In other words, the heat transfer fluid flows from the second heat exchanger to the first heat exchanger without (active) removal of heat therebetween (as used herein, active removal of heat is via a component configured to remove heat from the heat transfer fluid, for example the heat removal region). Positioning the second heat exchanger in the fluid circuit before the first heat exchanger ensures that the heat transfer fluid is at an optimal temperature upon entry to the first heat exchanger to balance recovery of water from the anode off-gas with coking in the anode off-gas in components downstream of the first heat exchanger.

The heat removal region (which may also be referred to as a heat sink and may remove heat for a useful purpose as set out below) is configured to remove heat from the heat transfer fluid to maintain the heat transfer fluid in an operating range of temperature. The heat removal region may comprise a heat exchanger or a pipe for transferring heat to its surroundings, such as a heating system (for example an underfloor heating system).

Positioning the heat removal region in the fluid circuit subsequent to the first heat exchanger maximises the temperature of the heat transfer fluid upon entry to the heat removal region (because the anode off gas is typically one of the hottest fluids in the fuel cell system), and so maximises the heat which may be removed from the heat transfer fluid at the heat removal region (e.g. removed from the heat transfer fluid for use elsewhere).

The heat removed from the heat transfer fluid at the heat removal region may be usefully employed to heat another liquid (for example a hot water supply to a building or vehicle or a hot water system for heating a building or vehicle via radiators or underfloor heating or pre-heating cold water entering a hot water system, in each case for immediate use or for storage and later release) or a gas (for example a cabin heater of a vehicle or a space heater in a building). The heat removal region may comprise a fan, but its use is minimised to minimise parasitic electrical consumption.

The fluid circuit may be a continuous or sealed fluid circuit. Thus, the heat transfer fluid may be pumped around the fluid circuit from second heat exchanger where thermal energy is added to the heat transfer fluid, to first heat exchanger where thermal energy is added to the heat transfer fluid, to heat removal region where thermal energy is removed from the heat transfer fluid, and continues in a loop to second heat exchanger where thermal energy is added to heat transfer fluid, and so on. The pump may be positioned in any location within the fluid transfer circuit which allows the pump to pump the heat transfer fluid around the circuit.

The heat transfer fluid has a greater heat capacity than the anode off-gas, and so the amount of energy transferred to the heat transfer fluid at the first heat exchanger may be relatively low. Thus, it is unimportant whether anode off-gas and heat transfer fluid temperatures converge at the exit the first heat exchanger. As a result, a parallel or a counterflow heat exchanger may be used for the first heat exchanger. In general, each of the heat exchangers may be parallel or counterflow heat exchangers. Preferably, counterflow heat exchangers are used.

As used herein, removal or removed typically refers to removal of heat (also referred to as thermal energy) from the heat transfer fluid and indeed from the system and added typically refers to addition of heat to the heat transfer fluid and the system. A heat exchanger may comprise a plurality of heat exchange elements, and is configured to transfer heat from a first fluid to a second fluid (and/or vice versa).

The stack may further comprise an anode inlet for supply of gas to and anode of the fuel cell, the gas may be fuel, and the anode off-gas is exhausted from the anode via the anode off-gas outlet. The stack may further comprise a cathode inlet, and a cathode off-gas outlet for supply and exhaust of gas to and from a cathode of the fuel cell.

The fuel cell may be a solid oxide fuel cell. The fuel cell stack comprises a plurality of repeat units (cell units) arranged one atop the next. Each repeat unit having electrochemically active layers comprising an anode and a cathode, separated by an electrolyte, which may be coated or deposited on a support plate, for example a metal support plate, of the repeat unit. Each repeat unit comprises a separator plate to separate the electrochemically active layers of a cell unit from the metal support plate of a neighbouring cell unit. The fuel cell stack may be an intermediate-temperature solid oxide fuel cell stack, the operating temperature of the fuel cells may be between 100° C. and 1000° C., preferably 250° C. and 850° C., more preferably 450° C. and 650° C.

The fuel cell system may include a separator to receive the anode off-gas from the first heat exchanger and configured to separate condensed water from the anode off-gas from anode off-gas containing remaining water vapour. The separator removes condensed (liquid) water from the anode off-gas and stores it in a tank for re-use in the fuel cell system, which may enable the fuel cell system to be self-sufficient in water.

The fuel cell system may comprise a burner through which the anode off-gas is routed, subsequent to the separator, and remaining fuel in the anode off-gas combusted, and wherein the combustion products are routed to the second heat exchanger to provide said heat to the heat transfer fluid. Subsequent to the second heat exchanger, the combustion products may be routed to a flue, and via the flue to atmosphere. The heat transfer fluid is at its coolest upon entry to the second heat exchanger as a result of the second heat exchanger being located upstream of the first heat exchanger and immediately downstream of the heat removal region. This means that the combustion products are efficiently cooled, to a low temperature, by transfer of heat to the heat transfer fluid and so a reduced amount of cooling is needed in the flue. The combustion products may be routed through various other heat exchangers in the fuel cell system subsequent to the burner and prior to the second heat exchanger, for example to exchange heat with air and fuel prior to their provision to the fuel cell stack.

The fuel cell system may comprise a top up line configured to supply fuel to burner, wherein use of fuel by the burner is controllable to increase a heat content of the combustion products and thereby increase the temperature of the heat transfer fluid. The top up line may be used to increase the temperature of the heat transfer fluid via exchange with the heat transfer fluid at the second heat exchanger. The fuel used in the top up line may be natural gas, and may be the same fuel as supplied to the fuel cell system for use in the stack. The burner is also provided with a supply of oxidant, for example in the form of cathode off-gas.

The heat removal region may comprise a third heat exchanger configured to remove heat from the heat transfer fluid to another medium. The heat removed from the heat transfer fluid at the heat third heat exchanger may be usefully employed to heat another liquid (for example a hot water supply to a building or vehicle or a hot water system for heating a building or vehicle via radiators or underfloor heating) or a gas (for example a cabin heater of a vehicle, a direct air heater in a building (to wherein the gas is the air in the building), or an indirect air heater (wherein the gas exchanges heat with air, and the air is supplied to the building, via an air-to-air hear exchanger).

The mass flow rate of the other medium may be controllable to control the rate of heat removal from the heat transfer fluid. Control of the mass flow rate of the other medium allows control the rate of heat removal from the heat transfer fluid and thereby allows control of the temperature of the heat transfer fluid at a desired temperature.

The other medium may be a gas, and wherein the gas is driven through the third heat exchanger by a controllable fan configured to control heat transfer from the heat transfer fluid. The gas may be air and is warmed by the third heat exchanger and is used to heat an enclosed volume. For example the gas heated at the third heat exchanger may be used heat a volume of air in a building or vehicle (e.g. a cabin heater). Use of the fan may be minimised by a control system to reduce energy usage by fan (e.g. electricity by electric fan), which is a parasitic load on the electrical energy produced by the fuel cell. The fan is preferentially turned off before the pump speed is reduced.

Alternatively the other medium may be a liquid (for example water or other coolant) driven by a pump of controllable speed, which may be usefully employed (for example as a hot water supply to a building or vehicle or a hot water system for heating a building or vehicle via radiators or underfloor heating).

The heat removal region may comprise a fourth heat exchanger in the fluid circuit configured to remove heat from the heat transfer fluid to a heat reservoir if the temperature of the heat transfer fluid is greater than the temperature of the heat reservoir and provide heat to the heat transfer fluid from the heat reservoir if the temperature of the heat transfer fluid is less than the temperature of the heat reservoir. The fourth heat exchanger is positioned upstream of the third heat exchanger, if present, such that the maximum useful heat may be removed from the heat transfer fluid at the fourth heat exchanger before the heat transfer fluid arrives at the third heat exchanger. I.E. the fourth heat exchanger is placed in the fluid circuit between the first heat exchanger and the third heat exchanger.

The heat reservoir may comprise a hot water circuit in which water circulates. The hot water circuit may be used to heat a medium. The hot water circuit may comprise a heating system in a building (for example a house or office block) or used in a motive (or mobile) application, for example a mobile home (e.g. a campervan).

The fuel cell system may comprise a fifth heat exchanger positioned in the fluid circuit between the heat removal region and the first heat exchanger, and the fifth heat exchanger configured to provide heat to the heat transfer fluid. The fifth heat exchanger is positioned downstream of the heat removal region and upstream of the first heat exchanger. The fifth heat exchanger may cool components in the wider system installation, for example cooled inverters, batteries, or electric motors in an automotive installation, in order to cool the same and allow the heat transferred to the heat transfer fluid to be used in fluid circuit by increased temperature at the first heat exchanger (thereby reducing coking).

The pump may be controllable to control a flow rate of heat transfer fluid around the fluid circuit. Controlling the pump speed may be used to control the temperature of the heat transfer fluid and thereby to control condensing temperature of the anode off-gas at the first heat exchanger.

Controlling the pump speed may also minimise required the rate of heat removal from the heat transfer fluid at fourth heat exchanger, (e.g. by increasing the pump speed in preference to use of a fan associated with the fourth heat exchanger, thereby minimising parasitic electrical consumption.

One or more of the pump and the rate of heat removal in the heat removal region may be controlled by an algorithm to maintain a target temperature of the heat transfer fluid subsequent to the first heat exchanger. The target temperature may be 0-140 deg C., preferably 10-100 deg C., more preferably 20-60 deg C., preferably still 40-60 deg C. The algorithm may, for example, control the target temperature to be around 60 C. for a balance between reforming water self-sufficiency and avoiding coking in the burner and related components. Use of fuel in the burner, where present, supplied by a top up line to the burner may also be controllable by the algorithm to maintain the target temperature. The algorithm prioritises adjustment of the pump over use of a fan associated with the heat removal region and over use of the top up line. If the first heat exchanger is a counterflow heat exchanger it may be preferable to control the temperature of the heat transfer fluid based on the temperature of the heat transfer fluid prior to the first heat exchanger rather than subsequent to the first heat exchanger. If the first heat exchanger is a parallel flow heat exchanger it may be preferable to control the temperature of the heat transfer fluid based on the temperature subsequent to the first heat exchanger rather than prior to the first heat exchanger.

The target temperature may be controlled depending on an operating condition of the fuel cell system. The target temperature may be increased for a period of time (for example 10-100 hours) to increase the humidity of the anode off gas subsequent to the first heat exchanger in order to de coke (remove carbon build up as a result of coking) in components in the anode off-gas stream subsequent to the first heat exchanger. The target temperature may be reduced for a period of time (for example 10-100 hours) to increase water recovery from the anode off-gas is the water tank is at a low level.

The heat transfer fluid (which may also be referred to as a heat exchange fluid) may be chosen from a group comprising: water, refrigerant fluid, anti-freeze fluid, oil, mixed fluids, fuel and air.

The fuel cell system of the first aspect may also include a method or algorithm for controlling the temperature of a heat transfer fluid in a fuel cell system in which the heat transfer fluid is pumped around a fluid circuit by a pump of controllable speed and a heat removal region configured to remove heat from the heat transfer fluid to another medium, wherein a mass flow rate of the other medium is controllable to control the rate of heat removal, the method comprising: prioritising increasing pump speed over increasing the mass flow rate of the other medium as temperature of the heat transfer fluid rises, and prioritising reducing mass flow rate of the other medium over reducing pump speed as temperature of the heat transfer fluid falls.

The fuel cell system may be a fuel cell system fuel cell system comprising at least one fuel cell stack comprising at least one fuel cell, and having an anode inlet, an anode off-gas outlet for flow of anode off-gas; a first heat exchanger coupled to receive the anode off-gas which has been output form the anode off-gas outlet, the first heat exchanger configured to exchange heat between the anode off-gas and a heat transfer fluid to cool the anode off gas and heat the heat transfer fluid; a second heat exchanger that is configured to provide heat to the heat transfer fluid; a heat removal region that is configured to remove heat from the heat transfer fluid; and a pump configured to pump the heat transfer fluid around a fluid circuit in a flow direction of: heat removal region where thermal energy is removed, second heat exchanger where thermal energy is added, first heat exchanger where thermal energy is added. The other medium controllable to control the rate of heat removal may be a fluid with which the heat transfer fluid exchanges heat in the heat removal region.

The method minimises electrical consumption by preferentially using the pump over using the other medium, while maintaining control of the temperature of the heat transfer fluid. Driving the mass flow rate of the other medium is a source of parasitic electrical consumption of the electrical energy generated by the fuel cell, thus it is advantageous to reduce the mass flow rate of the other medium and may have a minimum mass flow rate of zero. Meanwhile, the pump may have a minimum speed to ensure circulation of the heat transfer fluid (i.e. a minimum mass flow rate of the heat transfer fluid of greater than zero). Reducing the mass flow rate of the other medium or reducing the pump speed reduces heat removed at a heat removal region, while increasing the pump speed or increasing the mass flow rate of the other medium increases heat removed at a heat removal region.

The method allows heat recovery into the heat removal region (for example at the fourth heat exchanger) to be maximised whilst recovering sufficient water by preference to high flow rate (using the pump) in over high mass flow rate of the other medium. In cases where the heat removal region comprises both the third and fourth heat exchangers, the method maximises heat recovered at the fourth heat exchanger which may be usefully employed (for example the recovered heat can be used to heat water tank or air/water for space heating).

The other medium may be a gas (for example air) driven by a fan of controllable speed or a liquid (for example coolant or water) driven by a pump of controllable speed.

The method may control the mass flow rate of the other medium and pump speed to maintain the temperature of the heat transfer fluid in an operating range of temperatures. The operating range of temperatures may have a lower threshold and an upper, or maximum, threshold temperature, and the method maintains the temperature between the lower and upper thresholds.

The method may control the temperature of the heat transfer fluid to a target temperature, with the operating range being within a threshold (e.g. within 30, 20, 10 deg C.) of that temperature. The target temperature may be 0-140 deg C., preferably 10-100 deg C., more preferably 20-60 deg C., preferably still 40-60 deg C. The method may, for example, control the target temperature to be around 60 C. for a balance between reforming water self-sufficiency and avoiding coking in the burner and related components. Use of fuel in a burner, where present, supplied by a top up line to the burner may also be controllable by the algorithm to maintain the target temperature. The algorithm prioritises adjustment of the pump over use of a fan associated with the heat removal region and over use of the top up line. If the first heat exchanger is a counterflow heat exchanger it may be preferable to control the temperature of the heat transfer fluid based on the temperature of the heat transfer fluid prior to the first heat exchanger rather than subsequent to the first heat exchanger. If the first heat exchanger is a parallel flow heat exchanger it may be preferable to control the temperature of the heat transfer fluid based on the temperature subsequent to the first heat exchanger rather than prior to the first heat exchanger.

The method may cause an increase of the pump speed toward a maximum pump speed if the temperature exceeds the maximum temperature of the operating range. I.E. use of the pump is preferred over increasing the mass flow rate of the other medium to minimise parasitic electrical consumption.

The method may, if the temperature continues to exceed the maximum temperature of the operating range for longer than a threshold time after the increase of pump speed, cause an increase of the mass flow rate of the other medium. The threshold time may be a time constant characteristic of PID controllers adapted to control each of the pump speed and the mass flow rate of the other medium. Alternatively, the threshold time may be a pre-set value, for example 10, 20, or 30 minutes.

The method may, if the temperature is less than the maximum temperature of the operating range, cause a reduction of the mass flow rate of the other medium to zero. This reduces parasitic electrical consumption by reducing the speed and eventually turning off the means by which the other medium is driven, for example by reducing a fan speed if the other medium is a gas, or reducing a pump if the other medium is a fluid.

The method may, if the temperature continues to be less than the maximum temperature of the operating range for longer than a threshold time after the reduction of mass flow rate of the other medium, further reduce the pump speed toward a minimum pump speed. The threshold time may be a time constant characteristic of PID controllers adapted to control each of the pump speed and the mass flow rate of the other medium. Alternatively, the threshold time may be a pre-set value, for example 10, 20, or 30 minutes.

In examples where a burner is present, and the combustion products thereof may be routed to the second heat exchanger, use of additional fuel in the burner (via the top up line) is also be controllable by the algorithm to maintain the target temperature, i.e. to increase the temperature of the heat transfer fluid should it be below the minimum temperature. The algorithm prioritises adjustment of the pump and fan over use of the top up line for overall system efficiency.

The method may also comprise adjusting the maximum and minimum temperatures of the operating range. The algorithm may reduce the maximum temperature if the level of water in the tank is low. The method may increase the minimum temperature if the length of time that the system continually operates with the temperature at (or within a threshold temperature of) the minimum exceeds a threshold period of time. These adjustments may allow the method to adjust the parameters to compensate for changes in the overall system over time (for example, a reduced overall efficiency, leading to changes in composition of the anode off gas and changes in optimum operating temperature, over the lifetime of the system).

The temperature may be a first temperature and method may monitor the first temperature of heat transfer fluid subsequent to a first heat exchanger in the fluid circuit and comprise determining that the first temperature is such that the heat transfer fluid may freeze and increasing the temperature of the heat transfer fluid and/or determining that the temperature of water condensed at the first heat exchanger and entering a storage tank subsequent to the first heat exchanger may freeze and increasing the temperature of the heat transfer fluid.

The method may cause an increase of the temperature of the heat transfer fluid by a) supplying fuel to a burner configured to combust said fuel and routing the combustion products to a second heat exchanger to heat the heat transfer fluid, or b) reducing fan speed, or c) reducing pump speed. This prevents damage to the system by freezing of fluid therein. The condensing water is pure water, so will freeze below 0 deg C. under normal conditions. The freezing point of the heat transfer fluid is dependent upon the identity of that fluid (for example, it may comprise a mixture of water and antifreeze),

The method may comprise monitoring a water level in a tank in which water is recovered from anode off-gas for reuse in a fuel cell stack, and a) determining that an increased rate of water recovery is required to at least maintain the water level, and increasing pump speed and/or increasing mass flow rate of the other medium in order to reduce the temperature of the heat transfer fluid, or b) determining that a decreased rate of water recovery may be tolerated, and reducing pump speed and/or reducing mass flow rate of the other medium in order to increase the temperature of the heat transfer fluid.

This enables the fuel cell system to be self-sufficient in water (where water recovered from the anode off-gas is used elsewhere in the system to reform fuel, e.g. to reform natural gas to methane or hydrogen).

For example, an increased rate of water recovery may be required if the level of water in the tank indicates the tank is less than half full, and/or if the level is dropping. The method prioritises increased pump speed over increased mass flow rate of the other medium, e.g. pump speed may be increased to max before mass flow rate of the other medium is increased from zero or increased from an existing value.

For example, a reduced rate of water recovery may be tolerated if the level of water in the tank indicates the tank is more than half full, and/or if the level is increasing. The method prioritises reduced mass flow rate of the other medium over reduced pump speed, I.E. mass flow rate of the other medium may be reduced to zero before pump speed begins to be reduced to minimum.

The method may comprise monitoring a second temperature of heat transfer fluid prior to the first heat exchanger. This provides the method (control algorithm) with further data to monitor the state of the system.

The method may comprise determining that the second temperature is such that the heat transfer fluid may freeze and supplying fuel to a burner configured to combust said fuel and routing the combustion products to a second heat exchanger in the fluid circuit to heat the heat transfer fluid. This prevents damage to the system by freezing of fluid therein.

The method may also comprise reducing the pump speed responsive to determining that the second temperature is such that the heat transfer fluid may freeze. Reducing the pump speed enables greater transfer of heat to the heat transfer fluid at the second heat exchanger, which is transferred around the fluid circuit by the pump (even at a minimum pump speed), and to the first heat exchanger which is positioned subsequent to the second heat exchanger. This helps prevent freezing at the first heat exchanger, and promotes faster warm-up of the fuel cell system from an off or idle state. The pump speed is reduced toward a minimum pump speed, and may further comprise ensuring that the pump speed is greater than or equal to a minimum pump speed.

In an example, the heat transfer fluid is water and it is determined that the heat transfer fluid may freeze if the temperature of the heat transfer fluid prior to the first heat exchanger is 0 deg C. In another example, the temperature) of the heat transfer fluid prior to the first heat exchanger may be less than zero if heat transfer fluid may be less than zero without freezing (e.g. includes antifreeze) but it may nonetheless be determined to supply fuel to the burner to add heat to the heat transfer fluid to prevent freezing of water in the first heat exchanger.

The temperature of the heat transfer fluid prior to the first heat exchanger may be monitored when the fuel cell system is in a dormant or off state, and if the temperature of the heat transfer fluid prior to the first heat exchanger is at or less than the freezing point of the heat transfer fluid (or water) then top up fuel may be burnt in the burner and the pump used to circulate the heat transfer fluid in the fluid circuit to prevent freezing of the heat transfer fluid and/or the water in the tank.

The other medium may be a gas, and method may control a speed of a fan which drives the gas to vary the mass flow rate of the gas and control the rate of heat removal in the heat removal region. The gas may be air. Heat transferred to the gas may be used to heat an enclosed volume.heat removed from the heat transfer fluid he

In an alternative, the other medium is a fluid (coolant, e.g. water, oil, antifreeze), and the fluid is driven by a pump of controllable speed to vary the mass flow rate of the fluid and control the rate of heat removal in the heat removal region.

In another example there is provided a method for controlling temperature of a heat transfer fluid in a fuel cell system to avoid freezing of the heat transfer fluid, comprising: monitoring a temperature of heat transfer fluid prior to a first heat exchanger in a fluid circuit in fluid communication with an anode off-gas outlet associated with at least one fuel cell stack and configured to exchange heat discharged from the anode with a heat transfer fluid; and if the temperature is less than a first threshold temperature, supplying fuel to a burner configured to combust said fuel and routing the combustion products to a second heat exchanger that is configured to provide heat to the heat transfer fluid, wherein the first heat exchanger is subsequent to the second heat exchanger in the fluid circuit.

The supply of fuel may be controlled to prevent freezing of the heat transfer fluid subsequent to a first heat exchanger and/or to prevent freezing of anode off-gas in the first heat exchanger. The monitoring takes place when the system is in a dormant or an operational state.

According to a second aspect of the present invention, there is provided a fuel cell system comprising: at least one fuel cell stack comprising at least one solid oxide fuel cell, and having an anode inlet, an anode off-gas outlet for flow of anode off-gas; a first heat exchanger coupled to receive the anode off-gas which has been output form the anode off-gas outlet, the first heat exchanger configured to exchange heat between the anode off-gas and a heat transfer fluid to cool the anode off-gas and heat the heat transfer fluid; a second heat exchanger that is configured to provide heat to the heat transfer fluid; a heat removal region that is configured to remove heat from the heat transfer fluid; a bypass path for the heat transfer fluid to bypass the heat removal region; and a pump configured to pump the heat transfer fluid around a fluid circuit in a flow direction of: first heat exchanger where thermal energy is added second heat exchanger where thermal energy is added, heat removal region where thermal energy is removed.

The bypass path allows a portion of the heat transfer fluid to bypass, i.e. not pass through, the heat removal region and so reduce heat removed from the heat transfer fluid in the fluid circuit. As a result, the temperature of the heat transfer fluid may be increased by use of the bypass. The pump is located in the fluid circuit but outwith the bypass path and the region bypassed by the bypass path.

The bypass path may comprise a controllable flow splitter to control a relative flow rate of the heat transfer fluid through the bypass path and through the heat removal region. The proportion of the heat transfer fluid passing through the bypass path and the heat removal region is controlled using the splitter to control the temperature of the heat transfer fluid, and thereby control the amount of water recovered from the anode off-gas. The flow splitter may be a valve, e.g. a controllable valve.

The heat removal region may comprise a fourth heat exchanger in the fluid circuit configured to remove heat from the heat transfer fluid to a heat reservoir if the temperature of the heat transfer fluid is greater than the temperature of the heat reservoir and provide heat to the heat transfer fluid from the heat reservoir if the temperature of the heat transfer fluid is less than the temperature of the heat reservoir. The heat reservoir may comprise a hot water circuit in which water circulates. The hot water circuit may be used to heat a medium. The hot water circuit may comprise a heating system in a house or used in a motive application, for example a mobile home (e.g. campervan).

The fuel cell system of the second aspect may also include a method or algorithm for controlling temperature of a heat transfer fluid in a fuel cell system in which the heat transfer fluid is pumped around a fluid circuit by a pump of controllable speed, a heat removal region configured to remove heat from the heat transfer fluid to another medium, wherein a mass flow rate of the other medium is controllable to control the rate of heat removal, and a bypass path for the heat transfer fluid to bypass the heat removal region comprising a controllable flow splitter to control a relative flow rate of the heat transfer fluid through the bypass path and through the heat removal region, the method comprising: prioritising increasing pump speed over increasing the mass flow rate of the other medium as temperature of the heat transfer fluid rises, prioritising reducing mass flow rate of the other medium over reducing pump speed as temperature of the heat transfer fluid falls, comprising: controlling the flow splitter to increase the flow rate of heat transfer fluid through the bypass path to increase the temperature of the heat transfer fluid.

The fuel cell system may be a fuel cell system comprising: at least one fuel cell stack comprising at least one solid oxide fuel cell, and having an anode inlet, an anode off-gas outlet for flow of anode off-gas; a first heat exchanger coupled to receive the anode off-gas which has been output form the anode off gas outlet, the first heat exchanger configured to exchange heat between the anode off-gas and a heat transfer fluid to cool the anode off gas and heat the heat transfer fluid; a second heat exchanger that is configured to provide heat to the heat transfer fluid; a heat removal region that is configured to remove heat from the heat transfer fluid; a bypass path for the heat transfer fluid to bypass the heat removal region; and a pump configured to pump the heat transfer fluid around a fluid circuit in a flow direction of: first heat exchanger where thermal energy is added second heat exchanger where thermal energy is added, heat removal region where thermal energy is removed.

Reducing the flow rate of heat transfer fluid through the heat removal region increases the temperature of the heat transfer fluid, thereby reducing coking in anode off gas in components downstream of the first heat exchanger, and reduces warm up time of the system from an idle or off state. It also enables greater responsiveness to frost protection or prevention measures (where fuel is burnt in the burner, and heat transferred from the combustion products to the heat transfer fluid at the second heat exchanger.

The heat removal region may comprise a fourth heat exchanger in the fluid circuit configured to remove heat from the heat transfer fluid to a heat reservoir if the temperature of the heat transfer fluid is greater than the temperature of the heat reservoir and provide heat to the heat transfer fluid from the heat reservoir if the temperature of the heat transfer fluid is less than the temperature of the heat reservoir

The heat reservoir may comprise a hot water circuit in which water circulates. The hot water circuit may be used to heat a medium. The hot water circuit may comprise a heating system in a house or used in a motive application, for example a mobile home (e.g. a campervan).

### BRIEF DESCRIPTION OF THE DRAWINGS

FIG. 1 is a schematic of a prior art fuel cell system.

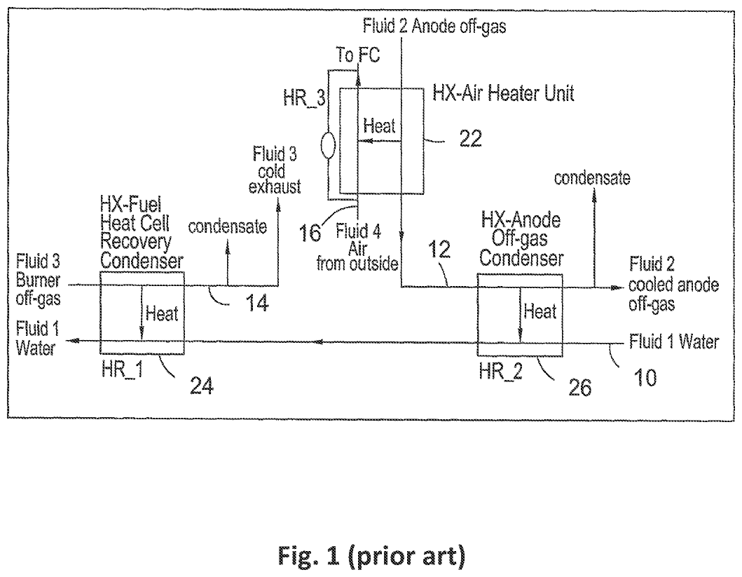

FIG. 2 is a schematic of a fuel cell system in accordance with the present invention.

FIG. 3 is a schematic of a fuel cell system in accordance with the present invention.

FIG. 4 is a schematic of a fuel cell system in accordance with the present invention.

FIG. 5 is a schematic of a fuel cell system in accordance with the present invention.

FIG. 6 is a schematic of a fuel cell system in accordance with the present invention.

FIG. 7 is a schematic of a fuel cell system in accordance with the present invention.

FIG. 8 is a schematic of a fuel cell system in accordance with the second aspect of the present invention.

FIG. 9 illustrates control processes for controlling a fuel cell system in accordance with the invention.

FIG. 10 Illustrates control processes for controlling a fuel cell system in accordance with the invention.

For Illustrative purposes only, the figures only indicate a single fuel cell stack. In various embodiments, (not shown) multiple fuel cell stacks are provided, and in still further embodiments multiple fuel cell stacks each comprising multiple fuel cells are provided. It will be appreciated that the anode and cathode inlets, outlets (off-gas), ducting, manifolding, and temperature sensors and their configuration are modified as appropriate for such embodiments, and will be readily apparent to a person of ordinary skill in the art.

In the following figures and description like reference numerals will be used for like elements in different figures.

### DETAILED DESCRIPTION

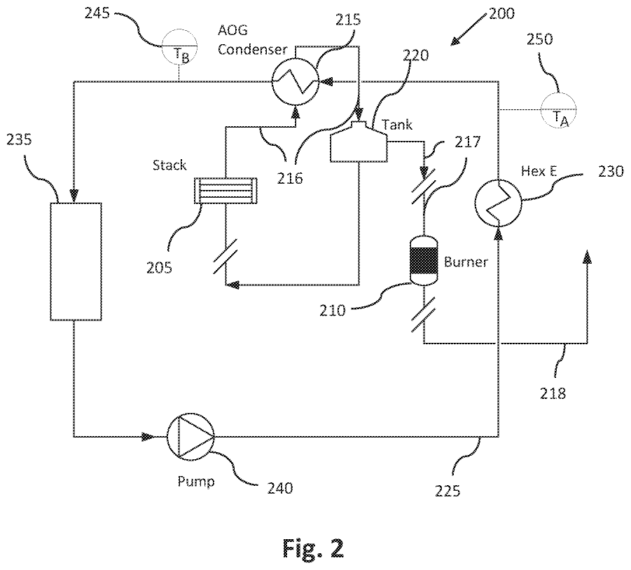

Referring to FIG. 2, fuel cell system 200 is shown. The fuel cell system 200 includes a fuel cell stack 205 is a metal-supported IT-SOFC fuel cell stack, comprising metal-supported IT-SOFC fuel cells, but may be any other type of fuel cell stack. Each fuel cell has an anode side, electrolyte layer, and cathode side. Each fuel cell layer in the fuel cell stack is separated by an electrically conducting gas impermeable metal interconnect plate (interconnector) (not shown). Fuel cell stack endplates and compression means (not shown) are also provided. Reference herein to fuel cell is to the full set of fuel cells which form the fuel cell stack. An electrical load is placed across the fuel cell. The fuel cell stack has an anode inlet and anode outlet in fluid communication with the anode of the fuel cells in the fuel cell stack. The anode inlet provides fuel to the anode of the fuel cells. The fuel may be hydrogen gas or methane, which is produced from a supply of natural gas and water vapour via reformation in a reformer (not shown). Alternatively, the fuel may be natural gas mixed with water vapour which is subsequently reformed to hydrogen or methane within the fuel cell stack. The anode outlet is an exhaust for fluids from the anode side of the fuel cells in the fuel cell stack, these fluids will be referred to as anode off-gas and comprise unused fuel, and water vapour.

A fuel cell stack anode inlet is in fluid flow communication with fuel cell anode inlet for the flow of anode inlet gas to the anode side of fuel cell. A fuel cell anode outlet is in fluid flow communication with fuel cell stack anode off-gas outlet for the flow of anode off-gas.

A fuel cell stack cathode inlet is in fluid flow communication with a fuel cell cathode inlet for the flow of cathode inlet gas to the cathode side of fuel cell. A fuel cell cathode outlet is in fluid flow communication with fuel cell stack cathode off-gas outlet for the flow of cathode off-gas.

Burner 210 (which may also be referred to as a tail gas burner) is in fluid flow communication with fuel cell stack anode and cathode off-gas outlets and has a burner exhaust, anode off-gas inlet and cathode off-gas inlet. Burner 210 lies on a fluid flow path from fuel cell stack anode and cathode off-gas outlets to tail-gas burner exhaust, and is configured for burning anode and cathode off-gases and producing a tall-gas burner off-gas. The burner may have a supply of fuel (also referred to as top-up fuel) from a fuel supply for burning in the burner. The burner off-gas may be routed from the burner 210 via an optional non-return valve (not shown) to a flue (not shown) to cool the burner off-gas and release the products to the environment surrounding the fuel cell system 200. Various components, generally represented by a double slash “//”, may be positioned between the burner and the flue, through which the burner off-gas is routed.

An anode off-gas fluid flow path is defined from fuel cell stack anode off-gas outlet to tank 220 (also referred to as separator) to an anode off-gas inlet of tail gas burner 210. The anode off-gas may pass through other components between the tank 220 and the burner 210.

An anode inlet gas fluid flow path (not shown in full) is defined from a fuel source to the fuel cell anode inlet (optionally via a steam reformer). Water, sourced from the tank 220, is added to the fuel for reformation of the fuel in the fuel cell stack or in a steam reformer (if present). Various components, generally represented by a double slash “//”, may be positioned on the anode inlet gas fluid flow path between the tank 220 and the fuel cell stack 205. These various components may include a reformer to reform fuel, an evaporator to evaporate fuel and water, and a heat exchanger to pre heat the anode (and cathode) inlet gas by transfer of heat from the burner off-gas as described in WO2015004419A1. These various components condition the anode inlet gas for use in the stack.

A cathode inlet gas flow path (not shown) is defined from an oxidant source to the fuel cell stack cathode inlet (and may pass through other components, such as heat exchangers to heat the oxidant before entry to the fuel cell, as described in WO2015004419A1). The cathode inlet gas flow path may include flow from a blower to and anode off-gas heat exchange to an air pre-heater heat exchanger to a reformer heat exchanger, to the fuel cell stack cathode inlet.

A cathode off-gas fluid flow path (not shown) is defined from fuel cell stack cathode off-gas outlet to cathode off-gas inlet of the burner 210.

Fuel cell system 200 includes a fluid circuit 225 configured to transport a heat transfer fluid between various components. The heat transfer fluid passes through numerous heat exchangers, each of which may comprise at least one heat exchange element or heat exchange surface, and are configured to transfer heat (otherwise referred to as thermal energy) between a first fluid, for example the heat transfer fluid, and a second fluid. The heat exchangers may be any type of heat exchanger, and may be co-flow or counter-flow.

The fluid circuit 225 of FIG. 2 comprises a first heat exchanger 215, a second heat exchanger 230, a heat removal region 235, and a pump 240. The pump is configured to pump the heat transfer fluid around the fluid circuit in a flow direction of: heat removal region 235, second heat exchanger 230, and first heat exchanger 215. The pump 240 is shown located in the fluid circuit 225 between the heat removal region 235 and the second heat exchanger 240, but alternatively be located at any suitable position within the fluid transfer circuit 225 which allows the pump 240 to pump the heat transfer fluid around the fluid transfer circuit 225. The pump may be a variable speed pump, the speed controllable to control a flow rate of heat transfer fluid around the fluid transfer circuit 225. The fluid transfer circuit 225 may be a continuous or sealed fluid circuit.

The heat transfer fluid, which may also be referred to as heat exchange fluid, may be any one of water, refrigerant fluid, anti-freeze fluid, oil, mixed fluids, fuel and air.

The first heat exchanger 215, also referred to as the anode off-gas heat exchanger or anode off-gas (AOG) condenser, is in fluid communication with the stack 205 and coupled to receive anode off-gas from the stack 205. The first heat exchanger 215 exchanges heat between the anode off-gas and the heat transfer fluid in the fluid circuit 225. The anode off-gas typically has a high temperature (for example, 400-800 C.) and so thermal energy is transferred to the heat transfer fluid at first heat exchanger 215.

The second heat exchanger 230 exchanges heat between the heat transfer fluid in the fluid circuit 225 and another fluid is a further circuit (not shown). Thermal energy is transferred to the heat transfer fluid at the second heat exchanger 230.

The heat removal region 235 is configured to remove heat from the heat transfer fluid. Thermal energy is removed from the heat transfer fluid at the heat removal region 235 to maintain the heat transfer fluid in an operating range of temperature. The heat removal region 235 may comprise one or more of a heat exchanger for transfer of heat from the heat transfer fluid to another fluid or a pipe for transferring heat from the heat transfer fluid to the surroundings of the pipe. The pipe may comprise a heating system (for example, an underfloor heating system).

The fluid transfer circuit 225 is provided with temperature sensors to measure the temperature of the heat transfer fluid. A first temperature sensor 245 is positioned to measure the temperature of the heat transfer fluid between the first heat exchanger 215 and the heat removal region 235. The first temperature sensor 245 measures temperature T_{B}, which is referred to as the anode off-gas (AOG) condensing temperature. A second temperature sensor 250 is positioned to measure the temperature of the heat transfer fluid between the second heat exchanger 230 and the first heat exchanger 215. The second temperature sensor 250 measures temperature T_{A}, which is referred to as the AOG inlet temperature.

In use, the pump 240 is operated to pump the heat transfer fluid around the fluid circuit 225 in a flow direction of: heat removal region where thermal energy is removed, second heat exchanger where thermal energy is added, first heat exchanger (AOG) where thermal energy is added. Heat is transferred to the heat transfer fluid at the second heat exchanger 230. The temperature of the heat transfer fluid subsequent to the second heat exchanger 230 is measured using the second temperature sensor 250. Subsequent to the second heat exchanger 230, the heat transfer fluid passes through the first heat exchanger 215, in which heat is transferred from the anode off-gas to the heat transfer fluid. The temperature of the heat transfer fluid subsequent to the first heat exchanger 215 is measured using the first temperature sensor 245. Subsequent to the second heat exchanger 230, the heat transfer fluid passes through the heat removal region 235, in which heat is transferred from the heat transfer fluid and may be usefully used, for example to heat a room or a hot water system.

The speed of the pump 240 (and therefore the rate of flow of heat transfer fluid around the fluid circuit 225) is controlled by an algorithm, which will be described in more detail with reference to

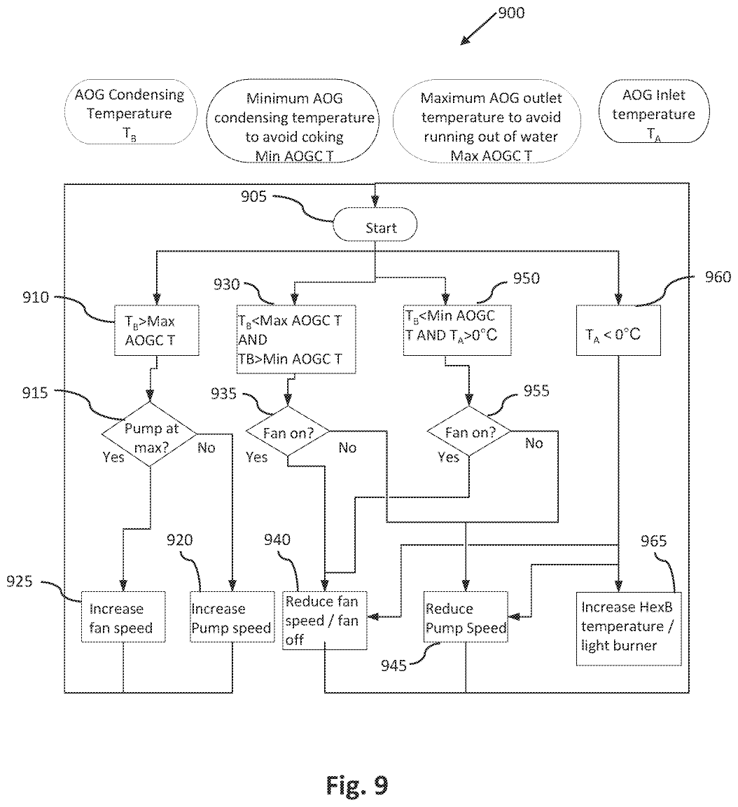

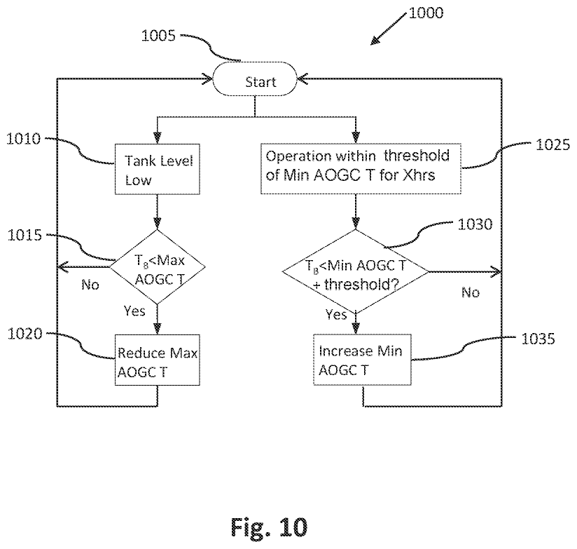

FIGS. 9 and 10. The algorithm monitors the temperature of the heat transfer fluid via first temperature sensor 245 and/or second temperature sensor 250 and adjusts the pump speed to maintain the heat transfer fluid within an operating range of temperature. The algorithm may increase the pump speed (thereby increasing the flow rate) to reduce the temperature of the heat transfer fluid, for example if the heat transfer fluid reaches an upper limit of the operating range of temperature, as a result of increasing the flow rate the temperature of the heat transfer fluid typically decreases. The algorithm may decrease the pump speed (thereby decreasing the flow rate) to increase the temperature of the heat transfer fluid, for example if the heat transfer fluid reaches a lower limit of the operating range of temperature, as a result of decreasing the pump speed the temperature of the heat transfer fluid typically increases.

Fuel is provided to the anode inlet (not shown) of fuel cell stack 205 for supply of gas to the anode(s) of the fuel cell(s), Water is sourced from the tank 220, vaporised, and added to the fuel. The water is used for reformation of the fuel in the fuel cell stack or in a steam reformer (if present) prior to the fuel cell stack.

Hot anode off-gas from the fuel cell stack anode off-gas outlet is routed to the first heat exchanger 215, where thermal energy is removed from the anode off-gas and transferred to the heat transfer fluid. As a result, the anode off-gas is cooled significantly. The anode off-gas is subsequently routed via an anode off-gas fluid flow path 216 to the tank 220, where condensate (water) is recovered from the anode off-gas and stored in the tank. As a result, the humidity of the anode off-gas is reduced and it may be referred to as dry anode off gas. The dry anode off-gas is routed (via path 217) from the tank 220 to the burner 210. The dry anode off-gas is mixed with oxidant (not shown) and combusted in the burner 210 to remove any remaining fuel, the combustion products, or burner off-gas, are routed to a flue (not shown) via path 218 and released to atmosphere. Ideally, little unused fuel is present in the anode off-gas and so little fuel is burnt in the burner 210. The oxidant combusted in the burner may be cathode off-gas routed from the fuel cell stack 205.

The amount of water recovered from the anode off-gas at the tank 220 (and so humidity of the dry anode off-gas) is dependent upon the temperature of the dry anode off gas which, in turn, is dependent upon the temperature of the heat transfer fluid at the entry to and exit from the first heat exchanger 215. If the heat transfer fluid is warmer, then less water is recovered from the anode off-gas than if the heat transfer fluid is cooler, Water is used for reformation of supply fuel to hydrogen, but is produced at the anode during operation of the fuel cell. In order to enable the fuel cell system to be self-sufficient with water, the algorithm may monitor the level of water in the tank and control the temperature of the heat transfer fluid in order to increase or decrease the rate at which water is recovered in the tank, to maintain the level of water in the tank within an operating range. The algorithm may determine that the level of water in the lank is low, and increase the pump speed to decrease the temperature of the heat transfer fluid, thereby decreasing the humidity of the dry anode off-gas and increasing the amount of water recovered to the tank 220.

Coking of system components between the tank and burner including the burner can occur in certain circumstances of the dry anode off-gas composition being unfavourable and the components being at unfavourable temperatures where coking can occur. Likelihood of coking can be reduced by increasing the water vapour content of the AOG. The algorithm may determine that the level of water in the tank is adequate or high, and decrease the pump speed to increase the temperature of the heat transfer fluid, thereby increasing the humidity of the dry anode off-gas and decreasing the amount of water recovered to the tank 220. A higher humidity of dry anode off-gas is favoured to reduce coking in the anode off-gas stream in components downstream of the tank 220, for example at the burner 210. Thus, the algorithm may maintain the heat transfer fluid at a temperature at which the level of water in the tank is constant (i.e. the level neither decreases nor increases).

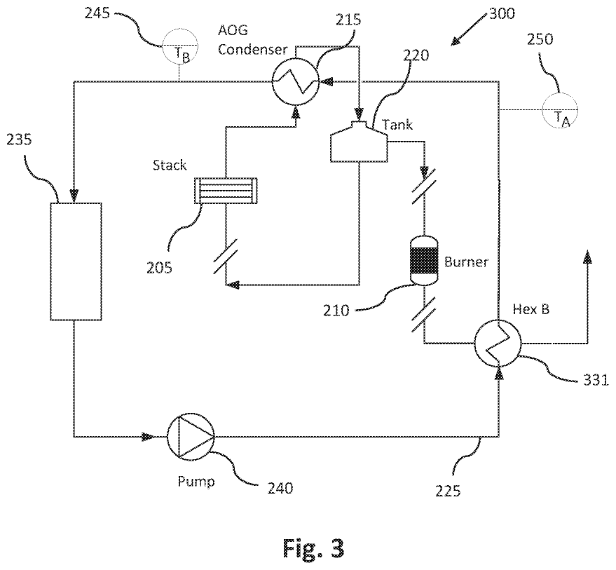

Referring to FIG. 3, a fuel cell system 300 is shown. Fuel cell system 300 is a variant of the fuel cell system 200 of FIG. 2. In the variant shown in FIG. 3, the burner off gas is routed to the second heat exchanger 331 and is the another fluid referred to above. The second heat exchanger 230 exchanges heat between the heat transfer fluid in the fluid circuit 225 and the burner off-gas. Thermal energy is transferred from the burner off-gas to the heat transfer fluid at the second heat exchanger 230. The burner off-gas leaves the second heat exchanger 230 and passes though an optional non-return valve (not shown) before exiting the fuel cell system via an exhaust flue assembly to atmosphere or another extraction system.

The burner may be equipped with a supply of fuel additional to any fuel in the anode off-gas. The additional fuel may be referred to as top up fuel, and originates from the same source as the fuel used in the fuel cell stack 205. Top up fuel may be burnt in the burner in order to raise the temperature of the burner off-gas and/or increase the heat transferred to the heat transfer fluid at the second heat exchanger 331. The algorithm may control burning of the top up fuel to increase the temperature of the heat transfer fluid, for example if the heat transfer fluid is at risk of freezing.

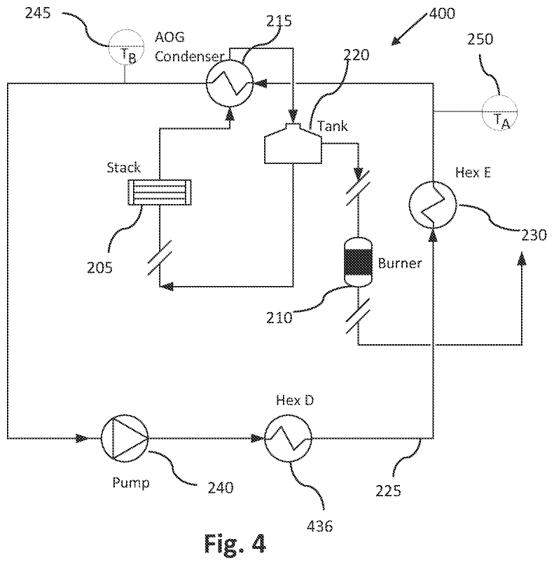

Referring to FIG. 4, a fuel cell system 400 is shown. Fuel cell system 400 is a variant of the fuel cell system 200 of FIG. 2. In the variant shown in FIG. 4, the heat removal region is represented as a third heat exchanger 436 and positioned within the fluid circuit subsequent to the pump 240 and prior to the second heat exchanger 230.

The third heat exchanger 436 is configured to remove heat from the heat transfer fluid and transfer heat to another fluid. In an example, the another fluid is a gas. The gas may be air, the air is warmed at the third heat exchanger and can be used to heat an enclosed volume. For example, the enclosed volume may be the cabin of a vehicle, in which case the third heat exchanger may be a radiator (e.g. the vehicle's radiator), or the enclosed volume may be air enclosed within rooms of a building. In an alternative example, the another fluid is a liquid. The liquid may circulate in a hot water circuit to heat a medium. The hot water circuit may comprise a heating system in a house or in a motive application, for example a mobile home (e.g. campervan). The liquid may be water and be used in a house or mobile home as a source of hot water.

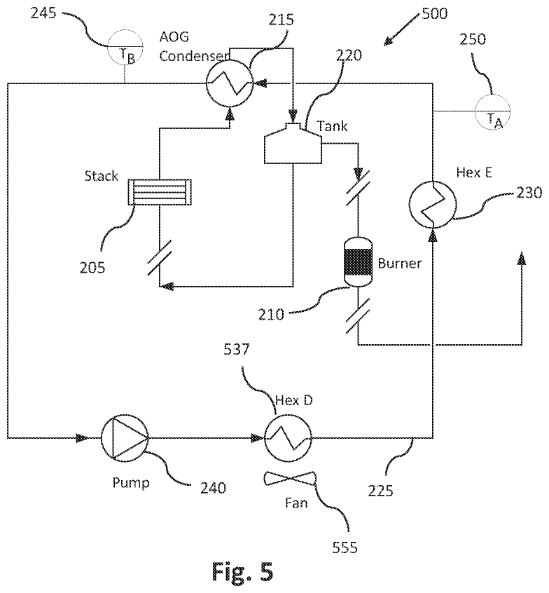

Referring to FIG. 5, a fuel cell system 500 is shown. Fuel cell system 500 is a variant of the fuel cell system 400 of FIG. 4. In the variant shown in FIG. 5, third heat exchanger 537 is configured to remove heat from the heat transfer fluid and transfer heat to a gas. The gas is driven through the third heat exchanger 537 by a fan 555. The fan 555 is controllable by the algorithm to vary the mass flow rate of gas through the third heat exchanger 537 and so configured to control heat transfer from the heat transfer fluid to the gas and thereby control the temperature of the mass transfer fluid. The mass flow rate of gas through the third heat exchanger 537 is proportional to the speed (rotations per time) of the fan. The fan is driven by electricity, the electricity is supplied by the fuel cell stack and the algorithm seeks to minimise usage of the fan, for example by increasing pump speed over increasing fan speed. The gas may be air, the air is warmed at the third heat exchanger and can be used to heat an enclosed volume. For example, the enclosed volume may be the cabin of a vehicle, in which case the third heat exchanger may be a radiator (e.g. the vehicle's radiator), or the enclosed volume may be air enclosed within rooms of a building.

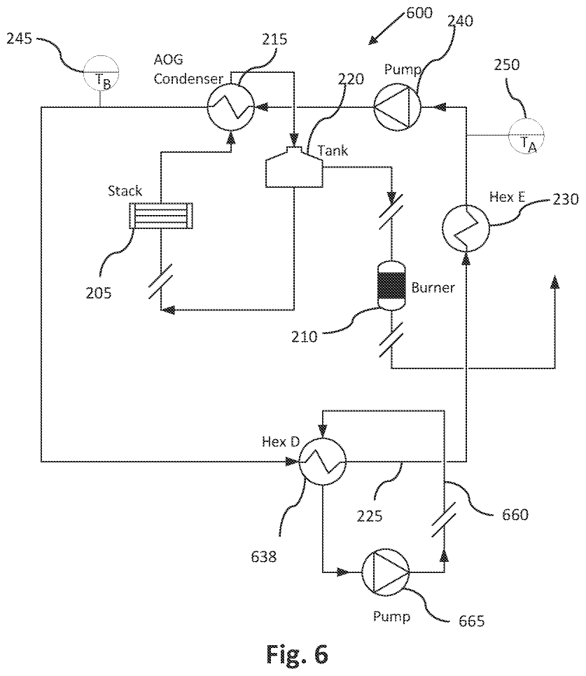

Referring to FIG. 6, a fuel cell system 600 is shown. Fuel cell system 600 is a variant of the fuel cell system 400 of FIG. 4. In the variant shown in FIG. 6, the pump 240 used for pumping the heat transfer fluid around the fluid circuit 225 is positioned in the fluid circuit between the second hear exchanger 230 and the first heat exchanger 215, i.e. the pump 240 is downstream of the second heat exchanger 230 and upstream of the first heat exchanger 215.

FIG. 6 is an example in which the heat removal region comprises the third heat exchanger 638 configured to remove heat from the heat transfer fluid and transfer heat to a liquid. The liquid circulates in liquid circuit 660, and is pumped around the circuit by a pump 665. The liquid may be water. Other components in the fluid circuit 660 are represented by the double slash “//”. A heat sink is located in the fluid circuit 660 to remove heat from the liquid circuit 660.

The liquid circuit 660 may circulate to heat a medium, in which case the liquid circuit 660 may be a continuous or sealed circuit. In this case, the hot water circuit may comprise a heating system in a house or in a motive application, for example a mobile home (e.g. campervan), and heat may be removed from the liquid circuit 660 via a radiator or a pipe for transferring heat to its surroundings, such as a heating system (e.g. underfloor heating system). Alternatively or additionally, the liquid circuit 660 may be used in a house or mobile home as a source of hot water, in which case the liquid circuit is non-continuous, and cool water is introduced to the liquid circuit 660 to replace hot water taken from the circuit.

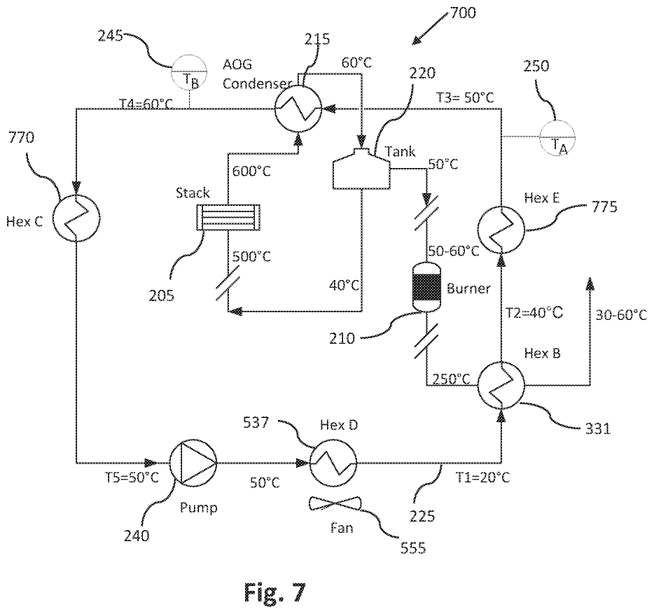

Referring to FIG. 7, a fuel cell system 700 is shown. Fuel cell system 700 is a variant of the fuel cell system 400 of FIG. 5. In the variant shown in FIG. 7, a fourth heat exchanger 770 and a fifth heat exchanger 775 are positioned within the fluid circuit 225. It is to be understood that the fourth heat exchanger 770 and the fifth heat exchanger 775 are optional and one may be present without the other.

The fourth heat exchanger 770 is positioned upstream of the third heat exchanger 537 and downstream of the first heat exchanger 215 subsequent to the first temperature sensor 245, in other words the fourth heat exchanger 770 is placed in the fluid circuit 225 between the first heat exchanger 215 and the third heat exchanger 537. The fourth heat exchanger 770 exchanges heat between the heat transfer fluid and a heat reservoir (not shown). The fourth heat exchanger 770 removes heat from the heat transfer fluid to the heat reservoir reservoir if the temperature of the heat transfer fluid is greater than the temperature of the heat reservoir and provides heat to the heat transfer fluid from the heat reservoir if the temperature of the heat transfer fluid is less than the temperature of the heat reservoir. The heat reservoir may comprise a liquid circuit, similar to that described with reference to FIG. 6 above. As such, heat removed from the heat transfer fluid at the fourth heat exchanger 770 serves a useful purpose, and the heat transferred within the fourth heat exchanger 770 is maximised by positioning the fourth heat exchanger 700 at the location in the fluid circuit 225 at which the heat transfer fluid is at its hottest (subsequent, e.g. immediately subsequent, to the first heat exchanger 215 and prior to the third heat exchanger 537).

The fifth heat exchanger 775 is positioned upstream of the first heat exchanger 215 prior to the first temperature sensor 245 and downstream of the second heat exchanger 331, in other words the fifth heat exchanger 775 is placed in the fluid circuit 225 between the second heat exchanger 331 and the first heat exchanger 215. The fifth heat exchanger 775 may be a heat source to provide heat to the heat transfer fluid or a heat sink to remove heat from the heat transfer fluid. In the case that the fifth heat exchanger 775 is a heat sink, it may be used to heat air in a building or vehicle (similar to the third heat exchanger 436, 537, 638 as described above), or it may be used to heat water for purposes of heating a building or vehicle, or to provide a supply of hot water (similar to the fourth heat exchanger 770 described above). The fifth heat exchanger 775 may represent more than one heat exchanger, the more than one heat exchanger being any combination of heat sinks and heat sources. For example, in an automotive application of the system 700, the fifth heat exchanger may exchange heat between the heat transfer fluid and other components of the automotive system such as cooled inverters, batteries, or electric motors, in order to cool the same and allow the heat transferred to the heat transfer fluid to be used in fluid circuit 225 by increased temperature at the first heat exchanger 215 (thereby reducing coking) and to heat other media external to the fluid circuit 225 via the third heat exchanger 537 and fifth heat exchanger 770. Further, in an automotive application the fifth heat exchanger 775 may remove heat from the heat transfer fluid and use it to heat cabin air.

In cases where the fuel supplied to the fuel cell stack originates from a pressure compressed fuel tank, the fifth heat exchanger 775 may remove heat from the heat transfer fluid and use it to heat the fuel upon exiting the tank (the temperature of the fuel as it exits the tank is low because of expansion of the fuel as it exits the high pressure tank).

In an alternative, the fifth heat exchanger 775 is positioned upstream of the second heat exchanger 331 and downstream of the third heat exchanger 537, in other words the fifth heat exchanger 775 is placed in the fluid circuit 225 between the third heat exchanger 537 and the second heat exchanger 331. This alternative arrangement is preferable if the fifth heat exchanger 775 is a heat sink to remove heat from the heat transfer fluid such that the heat transfer fluid upon entry to the first heat exchanger 215 is not cooled by a heat sink positioned in the fluid circuit 225 between it and the second heat exchanger 331.

Further shown in FIG. 7 are typical temperatures for a combined heat and power stationary application which is able to provide power (generated at the fuel cell stack) and heat (recovered from the heat transfer fluid at the fourth heat exchanger 770 and/or the third hear exchanger 537) to a building or group of buildings. The typical temperatures shown in FIG. 7 are for the case where the fourth heat exchanger 770 removes heat from the heat transfer fluid and the fifth heat exchanger 775 provides heat to the heat transfer fluid. The typical temperatures are appropriate for the case where each heat exchanger is a parallel flow heat exchanger, nonetheless other types of heat exchangers may be used in the fuel cell system, for example counter-flow heat exchangers. A temperature of around 60 deg C. is achieved in the heat transfer fluid at the first temperature sensor 245, subsequent to the first heat exchanger 215, which is found to be an ideal temperature to recover sufficient water in the tank 220 and minimise coking in the components, including burner 210, through which the anode off-gas and burner off-gas passes (it will be understood that the specific temperature at the first temperature sensor required to balance water recover and coking is a function of fuel utilisation and based on operating space analysis).

As shown in FIG. 7, the temperature T1 of the heat transfer fluid subsequent to the third heat exchanger 537 is low. Heat is transferred to the heat transfer fluid at the second heat exchanger 331 and so the temperature T2 of the heat transfer fluid subsequent to the second heat exchanger 331 is greater than T1 (T2>T1). Heat is transferred to the heat transfer fluid at the fifth heat exchanger 775 and so the temperature T3 of the heat transfer fluid subsequent to the fifth heat exchanger 775 is greater than T2 and T1 (T3>T2>T1). Heat is transferred to the heat transfer fluid at the first heat exchanger 215 and so the temperature T4 of the heat transfer fluid subsequent to the first heat exchanger 215 is greater than T3, T2 and T1 (T4>T3>T2>T1). Heat is removed from the heat transfer fluid at the fourth heat exchanger 770 and so the temperature T5 of the heat transfer fluid subsequent to the fourth heat exchanger 770 is less than T4 (T5<T4). Heat is removed from the heat transfer fluid at the third heat exchanger 537 and so the temperature T1 of the heat transfer fluid subsequent to the third heat exchanger 537 is less than T5 (T1<T5).

In the example temperatures shown in FIG. 7, the medium to which heat is transferred at the fourth heat exchanger 770 is relatively warm (or has low capacity for exchange of heat) and so the temperature of the heat transfer fluid is reduced by a relatively small amount at the fourth heat exchanger 770, such that T5=T3, and a correspondingly larger temperature drop is evident between T5 and T1 via heat removed at the third heat exchanger 537. If the medium to which heat is transferred at the fourth heat exchanger 770 is relatively cool (or has high capacity for exchange of heat) and so the temperature of the heat transfer fluid is reduced by a relatively larger amount at the fourth heat exchanger 770, such that T5<13 (and T5=12 or T5<T2 but T5>T1), and a correspondingly lesser temperature drop is evident between T5 and T1 via heat removed at the third heat exchanger 537, because a lower rate of heat transfer from the heat transfer fluid is required at the third heat exchanger to maintain the heat transfer fluid within an operating temperature range. In such a case, the speed of the fan 555 may be zero (the fan is off) and so heat transfer from the heat transfer fluid at the third heat exchanger 537 is minimal, T5=T1, and the majority of heat removal from the heat transfer fluid is at the fourth heat exchanger 770 (where it may be used as described above, thereby increasing the overall efficiency of the system).

Table 1 summarises a number of example use cases described with respect to FIGS. 2-7 from the perspective of “heat in” to the heat transfer fluid in the fluid circuit 225, 825 (i.e. heat transferred to the heat transfer fluid at the respective heat exchanger) and “heat out” from the heat transfer fluid in the fluid circuit 225, 825 (i.e. heat transferred from the heat transfer fluid to some other medium at the respective heat exchanger). In the table, “HX” is used as shorthand for “heat exchanger”. It will be understood that the fourth heat exchanger 770, where present, can be configured to transfer heat to or from the heat transfer fluid, or can be operated as a heat reservoir to transfer heat to or from the heat transfer fluid depending upon current operating conditions, as is shown by the example use case of FIG. 7, options A-D below. It will be understood that the fifth heat exchanger, where present, can be configured to transfer heat to or from the heat transfer fluid, as is shown by the example use case of FIG. 7, options A-D below. FIG. 7, option A corresponds to the typical temperatures shown in that figure.

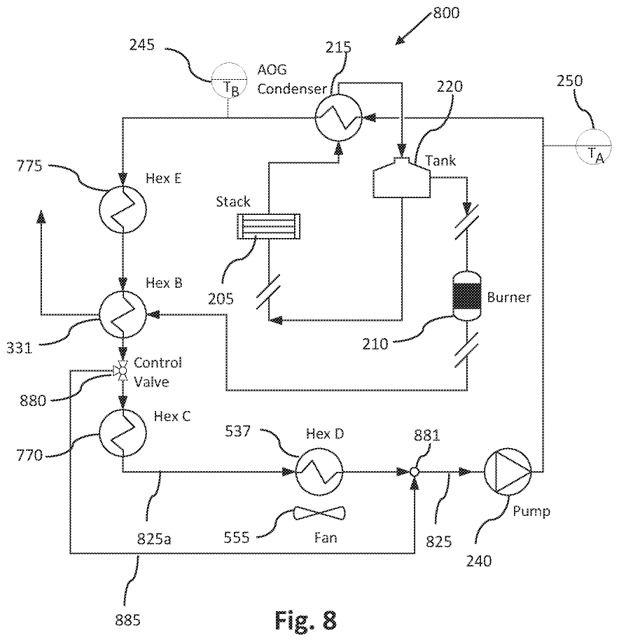

TABLE 1

| | | Second HX | Third HX 436, | Fourth HX | |
|---|---|---|---|---|---|
| Example use case | First HX 215 | 230, 331 | 537, 638 | 770 | Fifth HX 775 |
| FIG. 2 | Heat in | Heat in | Optional as part of heat | | Not present |
| | | | removal region 235 | | |
| FIG. 3 | Heat in | Heat in | Optional as part of heat | | Not present |
| | | | removal region 235 | | |
| FIG. 4 | Heat in | Heat in | Heat out | Not present | Not present |
| FIG. 5 | Heat in | Heat in | Heat out | Not present | Not present |
| FIG. 6 | Heat in | Heat in | Heat out | Not present | Not present |
| FIG. 7, option A | Heat in | Heat in | Heat out | Heat out | Heat in |
| FIG. 7, option B | Heat in | Heat in | Heat out | Heat in | Heat in |
| FIG. 7, option C | Heat in | Heat in | Heat out | Heat out | Heat out |
| FIG. 7, option D | Heat in | Heat in | Heat out | Heat out | Heat in |
| FIG. 8, option A | Heat in | Heat in | Heat out | Heat out | Heat in |
| FIG. 8, option B | Heat in | Heat in | Heat out | Heat out | Heat out |
| FIG. 8, option C | Heat in | Heat in | Heat out | Heat in | Heat in |
| FIG. 8, option D | Heat in | Heat in | Heat out | Heat in | Heat out |

Various use cases for the options given in table 1 are discussed above in reference to FIGS. 2-8. Generally, in the use cases of table 1, heat is removed from the heat transfer fluid at the third heat exchanger is used to heat a volume of air, or is expelled as waste heat (particularly in the cases where useful heat is recovered from the heat transfer fluid using the fourth heat exchanger).

Generally, in the use cases where heat is removed from the heat transfer fluid at the fourth heat exchanger, that heat is used to heat a liquid, typically water for use in a hot water system (to supply hot water to taps) or to heat a volume of air via radiators. This is in contrast to heating of air at the third heat exchanger because the temperature of the heat transfer fluid entering the fourth heat exchanger is higher than that entering the third heat exchanger, and so a larger amount of thermal energy can be transferred out of the heat transfer fluid at the fourth heat exchanger than at the third heat exchanger. The liquid with which thermal energy is exchanged at the fourth heat exchanger may, under certain circumstances (e.g. FIG. 7, option 8), provide heat to the heat transfer fluid (i.e. the fourth heat exchanger acts as a heat reservoir), which reduces the warm up time of the fuel cell system from a dormant or off state.

Generally, in the use cases where heat is transferred to the heat transfer fluid at the fifth heat exchanger, that transfer of heat is used to provide cooling to components external to the fuel cell system but within a wider system of which the fuel cell system is a part. Waste heat expelled by those components is usefully converted by the fuel cell system to raise the temperature of the heat transfer fluid to avoid coking, and may be usefully transferred out of the fuel cell system via the third and/or fourth heat exchangers. Generally, in the use cases where heat is removed from the heat transfer fluid at the fifth heat exchanger, that heat is used to heat other components which require only a small amount of thermal energy.

Referring to FIG. 8, a fuel cell system 800 is shown. Fuel cell system 800 is an alternative to the fuel cell systems described with reference to FIGS. 2 to 7. Fuel cell system 800 comprises a fuel cell stack 205, first heat exchanger 215, tank 220, and burner 210 as described above. In fuel cell system 800, the heat transfer fluid circulates in fluid circuit 825, and pumped around the fluid circuit 825 by pump 240. The fluid circuit 825 comprises the pump 240, first heat exchanger 215, fifth heat exchanger 775, second heat exchanger 331, fourth heat exchanger 770, and third heat exchanger 537. The pump is configured to pump the heat transfer fluid around the fluid circuit 825 in a flow direction of: pump 240, first heat exchanger 215, fifth heat exchanger 775, second heat exchanger 331, fourth heat exchanger 770, and third heat exchanger 537. Similar to the system 700 described above with reference to FIG. 7, the fourth heat exchanger 770 and fifth heat exchanger 775 are optional and one or both need not be present in the fuel cell system 800 of FIG. 8. Similar to the system 700 described above with reference to FIG. 7, the fourth heat exchanger 770 and the third heat exchanger 537 represent a heat removal region in which heat may be transferred from the heat transfer fluid. The first temperature sensor 245 is positioned subsequent to the first heat exchanger (in the fluid circuit between the first heat exchanger 215 and the fifth heat exchanger 775, or second heat exchanger 331 if the fifth heat exchanger 775 is not present). The second temperature sensor 250 is positioned prior to the first heat exchanger (in the fluid circuit between the pump 240 and the first heat exchanger 215).

The fuel cell system 800 of FIG. 8 includes a bypass path 885 for heat transfer fluid to allow at least a portion of the heat transfer fluid to bypass (i.e. not flow through) the heat removal region. A valve is positioned in the fluid circuit 825 between the second heat exchanger 331 and the fourth heat exchanger 770 (or between the second heat exchanger 331 and the third heat exchanger 537 if the fourth heat exchanger is not present). The valve splits the heat transfer fluid between flow through the heat removal region (through the continuation path 825a, which is a continuation of the fluid circuit 825) and the bypass path 885. A portion of the heat transfer fluid passes through the bypass path 885, while the remainder of the heat transfer fluid passes through the heat removal region (i.e. through third heat exchanger 537 and fourth heat exchanger 770). The bypass path and the path 825a through the heat removal region rejoin subsequent to the heat removal region at join point 881. Join point 881 is prior to the pump 240. The pump 240 may be positioned at any location in the fluid circuit 825 (i.e. the pump 240 is not positioned on the path 825a or on the bypass path 885.

The proportion of heat transfer fluid directed through the bypass path 885 and through the heat removal region is controlled by the control valve 880, which may be adjustable. The control valve may be adjusted to direct a relatively greater proportion of heat transfer fluid around the bypass path 885 (i.e. an increased mass flow rate of heat transfer fluid around the bypass path 885 and a correspondingly reduced mass flow rate of heat transfer fluid through the heat removal region) to increase the temperature of the heat transfer fluid. Conversely, the control valve may be adjusted to direct a relatively greater proportion of heat transfer fluid through the heat removal region (i.e. an increased mass flow rate of heat transfer fluid through the heat removal region and a correspondingly reduced mass flow rate of heat transfer fluid around the bypass path 885) to decrease the temperature of the heat transfer fluid. Adjustment of the control valve is controlled by the algorithm to achieve a desired temperature of heat transfer fluid (at the first temperature sensor 245 and/or second temperature sensor 250) and a desired rate of water recovery at the tank 220. As described above, decreasing the temperature of the heat transfer fluid causes an increased rate of water collection in the tank 220 and decreased humidity in the dry anode off-gas and so increased chance of coking downstream of the tank 220 while increasing the temperature of the heat transfer fluid causes a decreased rate of water collection in the tank 220 and increased humidity in the dry anode off-gas and so decreased chance of coking downstream of the tank 220.

FIG. 9 is a flow diagram representing a method 900 for control of the fuel cell systems described with reference to FIGS. 2-8. The method 900 is implemented by an algorithm to control the pump speed of pump 240 to control the mass flow rate of the heat transfer fluid around the fluid circuits 225, 825. The method 900 is implemented by an algorithm to control the mass flow rate of another medium to control the heat removed from the heat transfer fluid in the heat removal region. The method shown in FIG. 9, and described below, takes air as the another medium and so the mass flow rate of the another medium is controlled by controlling the fan 555 so control heat removal at the third heat exchanger 537. Equally, the another medium may be a liquid and the mass flow rate of the liquid controlled by controlling pump 665 to control the mass flow rate of liquid and so control heat removal at the third heat exchanger 638.

There exists a non-zero minimum mass flow rate of heat transfer fluid around the fluid circuit, while the minimum mass flow rate of the gas through the third heat exchanger is zero. A non-zero mass flow rate of the gas typically requires usage of electricity produced by the fuel cell stack to drive the gas through the third heat exchanger using fan 555. As temperature rises under closed circuit control, the pump is turned up to a maximum pump flow rate before the fan is turned on or turned up. And as temperature falls, the fan is turned down or turned off before the pump is turned down. Therefore method 900 prioritises use of the pump to drive the heat transfer fluid through the fluid circuit rather than use of the fan 555 to drive gas through the third heat exchanger.

The method monitors temperature T_{B}, which is referred to as the anode off-gas (AOG) condensing temperature, using the first temperature sensor 245 and monitors temperature T_{A}, which is referred to as the AOG inlet temperature, using the second temperature sensor 250. AOG inlet temperature (T_{A}) and AOG condensing temperature (T_{B}) are compared with a number of target temperatures: minimum AOG condensing temperature to avoid coking (Min AOGC T), maximum AOG outlet temperature to avoid running out of water (Max AOGC T), and the freezing point of the heat transfer fluid (0° C. in the example of FIG. 9).

The method 900 starts at start 905. At 910, if the AOG condensing temperature (T_{B}) is greater than Max AOGC T, it is determined at 915 whether the pump is at its maximum speed. If it is determined that the pump is not at its maximum speed, then at 920 the pump speed is increased in order to increase the mass flow rate of the heat transfer fluid and thereby aim to reduce the temperature of the heat transfer fluid. If it is determined that the pump is at its maximum speed, then at 925 the fan speed is increased in order to increase the rate of heat removal at the third heat exchanger. Subsequent to 920 and 925 the method returns to start 905, incorporating a suitable delay (not shown) to allow the effect of the increase in fan or pump speed to have an effect on the temperature of the heat transfer fluid. The delay is a control loop response time, which may comprise a proportional-integral-derivative (PID) controller for each of the fan and pump, each PID controller having a time constant which characterizes the delay. The PID controller for the fan in general has a different time constant than that for the pump.

At 930, if the AOG condensing temperature (T_{B}) is between the Max AOGC T and Min AOGC T (this may be referred to as the heat transfer fluid being within an operating range of temperatures), it is determined at 935 whether the fan is on. If it is determined that the fan is on, then at 940 the fan speed is reduced. The fan speed may be reduced to zero. If it is determined that the fan is not on, then at 945 the pump speed is reduced. The pump speed may be reduced to a minimum pump speed. Subsequent to 940 and 945 the method returns to start 905, incorporating a suitable delay (similar to that described above) to allow the effect of the decrease in fan or pump speed to have an effect on the temperature of the heat transfer fluid.

At 950, if the AOG condensing temperature (T_{B}) is less than the Min AOGC T and AOG inlet temperature (T_{A}) is greater than the freezing point of the heat transfer fluid (e.g. 0 deg C. for water), it is determined at 955 whether the fan is on. If it is determined that the fan is on, then at 940 the fan speed is reduced. The fan speed may be reduced to zero. If it is determined that the fan is not on, then at 945 the pump speed is reduced. The pump speed may be reduced to a minimum pump speed. Subsequent to 940 and 945 the method returns to start 905, incorporating a suitable delay (similar to that described above) to allow the effect of the decrease in fan or pump speed to have an effect on the temperature of the heat transfer fluid.

At 960, if the AOG inlet temperature (T_{A}) is less than the freezing point of the heat transfer fluid (e.g. OC for water), then it is determined that the temperature of the heat transfer fluid needs to be increased. The AOG inlet temperature (T_{A}) may be less than the freezing point of the heat transfer fluid if the fuel cell system is in an off or dormant state, if it is operated in a cold environment, or if the second and/or third and/or fourth heat exchanger, are exposed to ambient atmospheric conditions in some instalments. As a result, at 940 the fan speed is reduced. The fan speed may be reduced to zero. The pump speed may also be reduced at 945. In order to introduce heat into the system (in particular if the fuel cell system is in a dormant or off state), at 965 the heat transferred to the heat transfer fluid at the second heat exchanger is increased. This may be effected by lighting the burner 210 and burning top up fuel therein, the heat produced being transferred to the heat transfer fluid at the second heat exchanger and circulated around the fluid circuit by the pump. Subsequent to 940, 945, and 965 the method returns to start 905, incorporating a suitable delay (similar to that described above) to allow the effect of the decrease in fan or pump speed to have an effect on the temperature of the heat transfer fluid.

FIG. 10 is a flow diagram representing a method 1000 for control of the fuel cell systems described with reference to FIGS. 2.8, and allows the algorithm to adjust the Max AOGC T and Min AOGC T used in the method 900 of FIG. 9 to ensure adequate water recovery at the first heat exchanger 215 and in tank 220. Adequate water recovery means that the fuel cell system is self-sufficient for water by recovering water from the anode off gas to use in reforming (at a steam reformer or in the fuel cell stack) of fuel used at the anode.

The method 1000 starts at start 1005. The level of water in the tank 220 is monitored, and at 1010 it is identified that the level of water in the tank is low (e.g. below a threshold), therefore a greater rate of water recovery from anode off-gas is required. If the level of water in the tank is low, then at 1015 it is determined whether the AOG condensing temperature (T_{B}) is less than the Max AOGC T. If, at 1015, the AOG condensing temperature (T_{B}) is not less than the Max AOGC T, then it is assumed that the method 900 is acting to decrease the AOG condensing temperature (T_{B}) and the method returns to start 1005, and in doing so a greater rate of water recovery from anode off-gas will be achieved. If, at 1015, the AOG condensing temperature (T_{B}) is less than the Max AOGC T, then the method proceeds to reduce, at 1020, the Max AOGC T. The reduced Max AOGC T is used in the method 900, and as a result of reducing the Max AOGC T it is expected that, on average, the temperature of the heat transfer fluid is reduced, thereby increasing the rate of water recovery from anode off-gas and increasing the level of water in the tank 220. Subsequent to 1020 the method returns to start 1005, incorporating a suitable delay (similar to that described above) to allow the effect of the reduced Max AOGC T to have an effect on rate of water recovery from anode off-gas to the tank 220.

Returning to start 1005, the method 1000 also monitors the length of time that the system continually operates with the AOG condensing temperature (T_{B}) at or within a threshold temperature of the Min AOGC T. The threshold temperature may be 30, 20, 10, or 5 deg C. depending upon wider system requirements and installation. If the length of time that the system continually operates with the AOG condensing temperature (T_{B}) at (or within a threshold temperature of) the Min AOGC T exceeds a threshold period of time, then this is identified at 1025. The threshold period of time (“X” in FIG. 10) may be set at between 10 and 100 hours. Operation close to the Min AOGC T for long periods of time may lead to coking in components through which the dry anode off-gas passes. As a result, it is determined at 1030 whether the AOG condensing temperature (T_{B}) remains within a threshold temperature of the Min AOGC T. If, at 1030, the AOG condensing temperature (Ta) is greater than the Min AOGC T plus the threshold temperature, then the method returns to start 1005 and the length of time that the system continually operates with the AOG condensing temperature (T_{B}) at (or within a threshold temperature of) the Min AOGC T is reset. If, at 1030, the AOG condensing temperature (T_{B}) is greater than the Min AOGC T plus the threshold temperature, then the method continues to 1035 where the Min AOGC T is increased. The increased Max AOGC T is used in the method 900. As a result, method 900 will tend to increase the temperature of the heat transfer fluid, thereby reducing the likelihood of coking in the system components through which the dry anode off-gas passes. Subsequent to 1035 the method returns to start 1005, incorporating a suitable delay (similar to that described above) to allow the effect of the increased Min AOGC T to have an effect on the temperature of the heat transfer fluid, thereby reducing the likelihood of coking in the system components through which the dry anode off-gas passes.

In an example, the desired AOG condensing temperature (T_{B}) may be 50 deg C. for a particular system (based on the balance between sufficient water recovery and coking). The Min AOGC T may be set to 20 deg C., the threshold temperature to 30 deg C., and the threshold period of time to 24 hours. This means that the system may operate at T3<Min AOGC T+Threshold for up to 24 hours, which is expected to cause little coking, before Min AOGC T is increased to reduce water recovery and likelihood of coking.

It will be noted that method 1000 is a partial control logic as it shows only reducing Max AOGC T and increasing Min AOGC T. It will be understood that the Max AOGC T and Min AOGC T may be re-set to default values if the tank level is acceptable and the AOGC T is above the Min AOGC T. The re-set may occur immediately after start 1005 or otherwise periodically, for example every 10-100 hours.

The present invention is not limited to the above examples only, and other examples will be readily apparent to one of ordinary skill in the art without departing from the scope of the appended claims.

1. A fuel cell system comprising:
at least one fuel cell stack comprising at least one fuel cell, and having an anode inlet, an anode off-gas outlet for flow of anode off-gas;
a first heat exchanger coupled to receive the anode off-gas which has been output form the anode off-gas outlet, the first heat exchanger configured to exchange heat between the anode off-gas and a heat transfer fluid to cool the anode off-gas and heat the heat transfer fluid;
a second heat exchanger that is configured to provide heat to the heat transfer fluid;
a heat removal region that is configured to remove heat from the heat transfer fluid; and
a pump configured to pump the heat transfer fluid around a fluid circuit in a flow direction of: heat removal region where thermal energy is removed, second heat exchanger where thermal energy is added, first heat exchanger where thermal energy is added.

2. The fuel cell system of claim 1, further comprising a separator to receive the anode off-gas from the first heat exchanger and configured to separate condensed water from the anode off-gas from anode off-gas containing remaining water vapour.

3. The fuel cell system of claim 1, further comprising a burner through which the anode off-gas is routed, subsequent to the separator, and remaining fuel in the anode off-gas combusted, and wherein the combustion products are routed to the second heat exchanger to provide said heat to the heat transfer fluid.

4. The fuel cell system of claim 3, further comprising a top up line configured to supply fuel to burner, wherein use of fuel by the burner is controllable to increase a heat content of the combustion products and thereby increase the temperature of the heat transfer fluid.

5. The fuel cell system of claim 1, wherein the heat removal region comprises a third heat exchanger configured to remove heat from the heat transfer fluid to another medium.

6. (canceled)

7. The fuel cell system of claim 5, wherein the other medium is a gas, and wherein the gas is driven through the third heat exchanger by a controllable fan configured to control heat transfer from the heat transfer fluid.

8. (canceled)

9. The fuel cell system of claim 1, wherein the heat removal region comprises a fourth heat exchanger in the fluid circuit configured to remove heat from the heat transfer fluid to a heat reservoir if the temperature of the heat transfer fluid is greater than the temperature of the heat reservoir and provide heat to the heat transfer fluid from the heat reservoir if the temperature of the heat transfer fluid is less than the temperature of the heat reservoir.

10. The fuel cell system of claim 9, wherein the heat reservoir comprises a hot water circuit in which water circulates.

11. The fuel cell system of claim 1, further comprising a fifth heat exchanger positioned in the fluid circuit between the heat removal region and the first heat exchanger, and the fifth heat exchanger configured to provide heat to the heat transfer fluid.

12. (canceled)

13. The fuel cell system of claim 1, wherein one or more of the pump and the rate of heat removal in the heat removal region are controllable by an algorithm to maintain a target temperature of the heat transfer fluid subsequent to the first heat exchanger.

14. (canceled)

15. A method for controlling temperature of a heat transfer fluid in a fuel cell system in which the heat transfer fluid is pumped around a fluid circuit by a pump of controllable speed and a heat removal region configured to remove heat from the heat transfer fluid to another medium, wherein a mass flow rate of the other medium is controllable to control the rate of heat removal, the method comprising:
prioritising increasing pump speed over increasing the mass flow rate of the other medium as temperature of the heat transfer fluid rises, and
prioritising reducing mass flow rate of the other medium over reducing pump speed as temperature of the heat transfer fluid falls.

16-18. (canceled)

19. The method of claim 15, wherein if the temperature is less than the maximum temperature of the operating range, further comprising reducing the mass flow rate of the other medium to zero.

20. (canceled)

21. The method of claim 15, wherein the temperature is a first temperature and the first temperature of heat transfer fluid is monitored subsequent to a first heat exchanger in the fluid circuit and further comprising determining that the first temperature is such that the heat transfer fluid may freeze and increasing the temperature of the heat transfer fluid and/or determining that the temperature of water condensed at the first heat exchanger and entering a storage tank subsequent to the first heat exchanger may freeze and increasing the temperature of the heat transfer fluid.

22. The method of claim 15, further comprising monitoring a water level in a tank in which water is recovered from anode off-gas for reuse in a fuel cell stack, and a) determining that an increased rate of water recovery is required to at least maintain the water level, and increasing pump speed and/or increasing mass flow rate of the other medium in order to reduce the temperature of the heat transfer fluid, or b) determining that a decreased rate of water recovery may be tolerated, and reducing pump speed and/or reducing mass flow rate of the other medium in order to increase the temperature of the heat transfer fluid.

23. The method of claim 15, further comprising monitoring a second temperature of heat transfer fluid prior to the first heat exchanger.

24. The method of claim 23, further comprising determining that the second temperature is such that the heat transfer fluid may freeze and supplying fuel to a burner configured to combust said fuel and routing the combustion products to a second heat exchanger in the fluid circuit to heat the heat transfer fluid.

25. (canceled)

26. The method of claim 15, wherein the other medium is a gas, and wherein the gas is driven by a fan of controllable speed to vary the mass flow rate of the gas and control the rate of heat removal in the heat removal region.

27. A fuel cell system comprising:
at least one fuel cell stack comprising at least one solid oxide fuel cell, and having an anode inlet, an anode off-gas outlet for flow of anode off-gas;
a first heat exchanger coupled to receive the anode off-gas which has been output form the anode off-gas outlet, the first heat exchanger configured to exchange heat between the anode off-gas and a heat transfer fluid to cool the anode off-gas and heat the heat transfer fluid;
a second heat exchanger that is configured to provide heat to the heat transfer fluid;
a heat removal region that is configured to remove heat from the heat transfer fluid;
a bypass path for the heat transfer fluid to bypass the heat removal region; and
a pump configured to pump the heat transfer fluid around a fluid circuit in a flow direction of: first heat exchanger where thermal energy is added second heat exchanger where thermal energy is added, heat removal region where thermal energy is removed.

28. The fuel cell of claim 27, wherein the bypass path comprises a controllable flow splitter to control a relative flow rate of the heat transfer fluid through the bypass path and through the heat removal region.

29. The fuel cell of claim 27, wherein the heat removal region comprises a fourth heat exchanger in the fluid circuit configured to remove heat from the heat transfer fluid to a heat reservoir if the temperature of the heat transfer fluid is greater than the temperature of the heat reservoir and provide heat to the heat transfer fluid from the heat reservoir if the temperature of the heat transfer fluid is less than the temperature of the heat reservoir.

30-31. (canceled)
